(19) United States
(12) Patent Application Publication
(10) Pub. No.: US 2005/0275138 A1
(43) Pub. Date: Dec. 15, 2005

(54) Building material for forming an architectural surface covering and method for producing the same

(76) Inventors: Eric Rosen, Los Angeles, CA (US); Joel Stearns, Inglewood, CA (US)

Correspondence Address: MATTHEW A. NEWBOLES;STETINA BRUNDA GARRED & BRUCKER, SUITE 250, 75 ENTERPRISE, ALISO VIEJO, CA, 92656, US

(21) Appl. No.: 10/855,846

(22) Filed: May 27, 2004

(51) Int. Cl. B27N 3/10

(52) U.S. Cl. 264/299; 264/257; 264/294; 264/301; 264/306

(57) ABSTRACT

A building material for use in forming exterior surface coverings. According to a preferred embodiment, the building material consists of the combination of a paper material, bonding agent, and water. The building material can either be formed directly upon a substrate, such as a wall or ceiling, or otherwise formed as a sheet of material or molding that can thereafter be affixed to a given surface or substrate. The building materials can be customized to have a specific type of color, shape and texture, and can further be utilized in a wide variety of building applications.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

A wide variety of materials and techniques are known in the art for forming architectural structures to have a desired appearance, color and configuration. In this regard, materials such as stone, laminates, synthetic materials such as Corian, a registered trademark of DuPont, Inc., and a wide variety of hard woods can be deployed in countless configurations, styles and colors to impart a desired appearance. Moreover, with respect to drywall, the same can be modified to have a texturized appearance, as well as painted and/or covered in wall paper to achieve a desired appearance. Moreover, moldings, which are typically formed from wood, are likewise frequently deployed to enhance the appearance of a given room.

Notwithstanding the virtually countless options available with the aforementioned materials, several drawbacks are associated with virtually all types of such building materials that make the use thereof either impractical, cost prohibitive, difficult to construct or fabricate and/or maintain. For example, the use of stone, such as granite or marble, requires precise fabrication and further, due to weight constraints, can only be utilized in certain applications. Moreover, once in place, such stone fixtures are essentially permanent and thus can pose a substantial impediment when it becomes necessary to access certain structures, such as plumbing and the like. It is likewise difficult to utilize stone to cover large surface areas insofar as stone is typically provided in slabs of limited surface area. The use of such stone materials are further problematic insofar as the same are prone to become irreparably damaged to the extent the stone material ever becomes cracked or chipped.

These same drawbacks further apply to the use of wood. In this regard, wood, like stone, must be precisely fabricated for use in a particular application especially in cases where the wood grain must match a particular type of orientation. Wood can also become irreparably damaged, as can occur upon impact or when too much structural stress is applied thereto. Wood is often times limited, too, in its application due to a limited variety of wood types that are available to architects, designers, contractors and the like. Specifically, choices are often times limited between darker woods, such as cherry and mahogany, and lighter woods, such as maple or ash. While dyes and lacquers can be utilized to impart a desired color to wood, wood often times is ill suited for use to impart a desired texture to a large surface area, such as a wall, as opposed to limited accents such as moldings.

The other aforementioned materials and techniques, such as paint, the application of texturizing agents, such as orange peel for use on drywall, or the application of wall paper, are often times considered ill suited for use in certain applications. In this regard, texturizing agents are often times difficult to deploy and only impart a limited degree of texture to a given drywall surface. The use of paint, too, is limited in certain application insofar as the same can only impart a relative degree of sheen or gloss to the painted surface and not any type of texture. Moreover, to the extent multiple colors are utilized to paint a particular surface requires meticulous painting techniques that are time consuming and labor intensive. The use of wall paper also, has similar drawbacks insofar as the same is labor intensive to deploy, can be exceedingly difficult to repair if damaged, and is virtually impossible to customize insofar as virtually all types of wall paper are prefabricated and selections must be made amongst stock inventory.

In addition to the foregoing drawbacks, most building materials and building techniques are incapable or otherwise ill-suited for use in multiple architectural applications. In this regard, materials that are well suited for use in constructing and decorating walls and ceilings are ill-suited for use in forming counter tops and flooring. Additional problems occur to the extent building materials are sought to be utilized in both plumbing and non-plumbing applications. Specifically, materials that are well-suited for use in sinks, bathtubs and showers, such as stone or tile, are impractically suited for other applications, such as cabinetry. While certain synthetic materials, such as laminates and polymer-based counter tops such as Corian, discussed above, can be utilized in multiple applications, the same typically cannot be fabricated to have a customized appearance and typically must be chosen amongst stock product lines. Such materials further must be separately fabricated and further often times cannot be made to impart any type of desired texture or color.

As such, there is a substantial need in the art for a building material, and in particular a building material for forming architectural surface coverings, that substantially eliminates all of the aforementioned deficiencies with the above-identified classes of building materials. In this regard, there is a need for such a building material that is capable of being utilized in a wide variety of applications that can be customized to have a desired appearance, shape and texture over a surface area of unlimited dimensions. There is further a need for such a material that is easy to fabricate, install and may be formed to have desired properties for use in a given application, whether it be for use in decorating walls, forming counter tops, flooring or any of a variety of structures that are sought to possess a desired architectural appearance. There is additionally a need in the art for such a material and a method for making the same that are exceedingly simple, of low cost, light weight, exceptionally durable and exceptionally easy to repair. There is likewise a need for such a material that can be readily fabricated using known materials and capable of being customized for use in virtually all types of architectural applications.

### BRIEF SUMMARY OF THE INVENTION

The present invention specifically addresses and alleviates the above-identified deficiencies in the art. In this regard, the present invention is directed to a building material for forming surface coverings upon structures, such as walls, ceilings, counter tops, cabinetry, flooring and the like that can be customized to have a particular type of shape, color and texture. In its most general sense, the invention comprises the combination of a paper material, a bonding agent and water that can be fabricated as sheets or moldings for subsequent affixation to a given structure or otherwise can be directly applied upon a substrate to form the desired surface covering.

According to a preferred embodiment, the building material comprises, in parts by weight, 1 to 14 parts of a paper/water admixture, which can comprise any type of fibrous material, whether it be fabric, paper, combinations of dissimilar types of paper, or any other type of synthetic or natural fibers, as well as combinations thereof, that is mixed with water such that the ratio by weight of paper to water is approximately 3:16. The paper/water admixture is combined with a binding agent, which can comprise white glue alone, a thickening agent alone, or preferably the combination of white glue, such as Elmer's brand of white glue produced by Borden Corporation, and a thickening agent, which preferably comprises cornstarch mixed with water. In a preferred formulation, the thickening agent will comprise the combination of cornstarch and water that will be mixed such that the ratio of cornstarch to water, by weight, is approximately 1:8. In a preferred embodiment, the binding agent consists of 1-2 parts by weight of white glue, and 0.5-1.5 parts by weight cornstarch/water relative the to overall weight of the building composition. In a most highly preferred embodiment, the building material consists of approximately 7 parts paper/water admixture, 1.5 parts of white glue and 1 part of cornstarch/water admixture, all being present in approximate amounts.

With respect to the processes of formulating the building materials of the present invention, such process preferably comprises the steps of selecting the paper material, to which water is added and thereafter blended or ground with the paper to form a water/paper admixture. Such blending can be conducted for about 30 seconds to 60 seconds depending upon the type of paper utilized and how fine the paper size is to be attained, although shorter or longer times can be utilized. To the extent desired, dissimilar types of paper/water admixtures can be combined.

Thereafter, the bonding agent, namely, either white glue alone, thickening agent alone or the combination of white glue and thickening agent, are added and gently stirred in, preferably by hand or slow mixing. The amount of thickening agent (i.e., cornstarch) can be varied to control the thickness of such resultant second admixture or “mash” that the building material possesses. In further refinements of the invention, prior to mixing the bonding agent with the paper/water admixture, additives can be added to the bonding agent to impart a desired appearance, texture, or to provide a particular type of property, such as an antioxidant and/or preservative. In yet a further refinement of the invention, multiple “mashes” are formed (i.e., separately prepared combinations of paper and bonding agent) and combined to produce a resultant mash having multiple colors and textures as is imparted by the separate paper components of each separate mash. Likewise, in further refinements of the invention, once a mash is formed, various additives can be added to impart a further desired appearance or texture. For example, sand, confetti, metallic powder, string, and any of a variety of materials can be added following formation of a given mash. Additional additives to impart a desired property to the mash may also be added, such as a flame retardant, antioxidant, hardener, and/or preservative.

Once the mash has been formed, with or without desired additives, the same can either be directly applied to a substrate, such as a wall, ceiling or other fixture, by merely coating the mash upon such surface. Along these lines, it is contemplated that the same can be trowelled, sprayed or rolled directly upon the surface sought to be treated. Depending upon the thickness of the mash, the same can be stamped or otherwise texturized to possess a desired shape, pattern or configuration. In this regard, the mash will consist of a wet, dough-like fibrous clay that, once hardened, will form a durable material. Along these lines, it is contemplated that the building material may be packaged and shipped in its wet state and marketed as a pre-mixed composition.

Alternatively, the building material, once formed as a mash, can be formed as moldings or as sheets whereby the same are either poured into molds or otherwise applied to a substrate/backing, such as aluminum, which will thus cause the mash to harden to form a durable molding or sheet of material, which can be either smooth or texturized, that can be affixed to a given substrate, such as a wall or ceiling. When formed as a sheet, such sheet either while still drying or in its final dried and hardened state, can be cut to have a desired shape or appearance and otherwise mounted into position, whether it be for counter top, wall or other type of surface covering. Along these lines, when formed as a sheet, the mash may be formed to have a desired pattern, such as a fluted pattern or the like, that may be desired for a specific application. In certain formulations, the building material can also be sanded down or reshaped following fabrication thereof, and is also very easy to repair. With respect to the latter, the same can be effectuated by merely preparing a like amount of mash and using the same as a type of repair “putty” that can be used to fill in cracks and the like to the extent as may be necessary or desired for a given application.

It is therefore an object of the present invention to provide a building material that is operative to provide an architectural surface covering that is of simple formulation, durable, and capable of being utilized in a wide variety of applications.

It is another object of the present invention to provide a building material that can be customized to have a specific type of appearance, and in particular a specific type of color, shape and texture.

It is a further object of the present invention to provide a building material that can be readily made using known materials, is not labor intensive to fabricate, and can be easily repaired as compared to other types of building materials such as stone or wood.

### BRIEF DESCRIPTION OF THE DRAWINGS

These as well as other features of the present invention will become more apparent upon reference to the drawings

FIG. 1 is a flow chart depicting the sequential steps utilized in making the building materials of the present invention.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

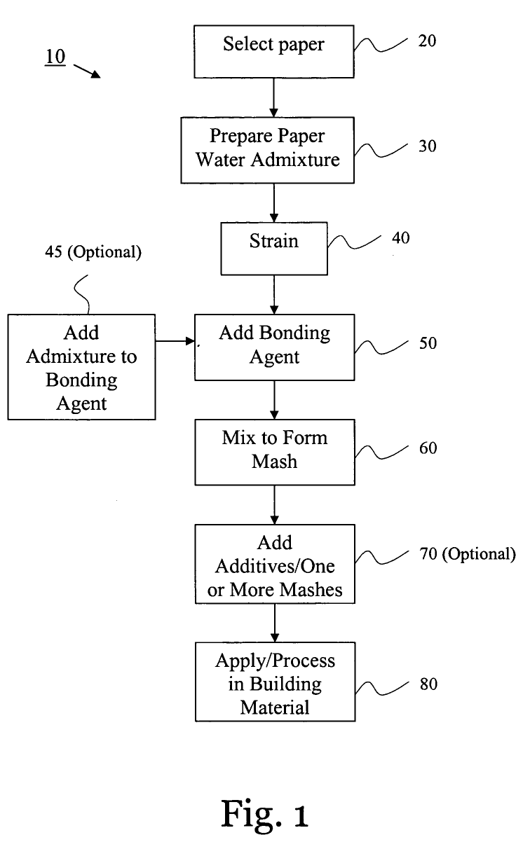

Referring now to FIG. 1, there is shown a process 10 for forming the building materials of the present invention. In this regard, the present invention is directed to building materials that can be utilized to form architectural surface coverings for use in a wide variety of applications, and further can be advantageously substituted for a variety of traditional building materials, such as stone, paint, wall paper, wood, and the like that further is substantially less expensive, easier to fabricate, able to have a customized appearance, shape and texture, and able to be used in a wider variety of applications than such prior art materials.

Such building materials comprise, according to the most basic formulation, the combination of a paper/water admixture and a bonding agent that are present within certain ranges by weight that, when mixed accordingly to the methodology of the present invention discussed more fully below, form a mash that can be formulated to have a specific type of color or multiplicity of colors, texture and shape. Such materials may be further processed for use in a wide variety of architectural applications, whether it be walls/ceiling design, counter tops, flooring, moldings and shower/bath fixtures.

With respect to the process 10 of the present invention, the initial step 20 comprises the selection of paper. Paper, as utilized in the context of the present invention, includes any type of fibrous paper material, including cardboard, newspaper, construction paper, colored paper and any and all types of stationery and print media. Paper further can include any type of natural and/or synthetic fibrous material, and can include any of a variety of fabrics formed from any of a variety of well known materials such as cotton, wool, synthetic fibers such as nylon or polyester, as well as combinations of such natural and synthetic fibers. Presently, however, it is believed that traditional paper materials, as would be understood by one of ordinary skill in the art are best suited for practice of the present invention.

With respect to the selection of the paper in step 20, the present invention advantageously allows for virtually any type of paper, including recycled paper, to be selected. As such, any type of paper having the desired texture or color can be chosen which in turn will impart the texture and color of the building material as eventually applied to form the external surface covering. Accordingly, it should be recognized that the present invention advantageously allows for virtually any type of paper material to serve as a basis for use in forming the building materials of the present invention and thus enables entities such as architects, interior decorators, contractors, home owners, and the like to have virtually limitless opportunities to customize the color and texture of the building materials disclosed herein.

Upon selection of the paper in step 20, a paper/water admixture is prepared in step 30. To that end, the paper selected in step 20 will be mixed with water in amounts sufficient to form a paper/water admixture that can be blended or ground, as can be accomplished through the use of a conventional industrial kitchen blender or any type of suitable industrial grinder. Preferably, the paper will be added to the water admixture blend in the form of torn strips, although it is contemplated that such pre-blend shredding will not necessarily be required. Moreover, in certain applications where it may be desired to pre-soften the paper/water admixture prior to blending, it is contemplated that the paper/water admixture may be prepared and allowed to sit for up to eight hours or longer before the blending process occurs. As a result of such pre-softening, the blending step 30 is greatly facilitated and allows for a more homogeneous mixture to be more easily and readily formed. Along these lines, it is contemplated that use of the grinder or blender may only be utilized for a short duration, which at present is believed to be from about 30 seconds to one minute. As will be readily recognized, a longer mixing time can be utilized for coarse paper whereas a shorter mixing time may be utilized for fine papers.

Once the paper/water admixture has been blended, the same is strained, preferably through a cheese cloth or paint strainer, such that the resultant admixture consists of paper and water that are present, by weight relative to one another, in the ratio of approximately 3:16, although other ratios will also likely perform well. In an optional step not shown, it is contemplated that one or more additional strained paper/water admixtures can be combined to produce a resultant paper/water admixture that in essence is a combination of two or more dissimilar paper types.

Thereafter, the paper/water admixture is combined with a bonding agent in step 50. With respect to the bonding agent, the same can comprise either white glue or a thickening agent. With respect to the latter, the same can preferably comprise the combination of water and cornstarch that are present relative to one another in a ratio of approximately 8 parts water to one part cornstarch by weight. The amount of cornstarch, however, is not critical. In a more highly preferred embodiment, the bonding agent comprises the combination of white glue and a thickening agent. With respect to the latter, a preferred thickening agent includes the cornstarch/water mixture discussed above; however, it is contemplated that a wide variety of thickening agents, such as a wide variety of polymers well-known in the art as thickening agents can be readily utilized in the practice of the present invention. In this regard, the thickening agent, which advantageously adjusts the rheology or thickness properties in the resultant building material as may be desired for specific types of applications, discussed more fully below, in some instances may be deemed optional and not utilized at all. Among such applications where the bonding agent can dispense entirely with the thickening agent would include applications where the building materials are prepared or designed for use as flat sheets or otherwise formed to have a minimal thickness.

With respect to the white glue element, the same may take any of a variety of such glues well-known in the art. Perhaps the most well-known of such white glue products include Elmer's Glue produced by the Borden Corporation of Columbus, Ohio.

Prior to combining the paper/water admixture with the bonding agent in step 50, an optional step 45 can be performed whereby additives can be introduced to the bonding agent before hand, in step 45. In such step, any of a variety of additives can be added to the bonding agent, whether it be to modify the appearance of the resultant building material, such as by texture or color, or may otherwise include an additive that affects the underlying properties of the resultant building material, such as a preservative, antioxidant, or property to enhance the characteristics of the building material, such as hardness. Such suitable additives will be readily understood by those skilled in the art and can easily be introduced by merely mixing the same in with the bonding agent, via step 45, through any of a variety of known techniques. In preferred embodiments, liquid additives will be added to the bonding agent prior to combining the bonding agent with the strained paper/water admixture. Non-liquid additives can optionally be added before or during the step of combining the bonding agent with the strained paper/water admixture.

The combination of the strained paper/water admixture and bonding agent will preferably be combined such that the resultant admixture will comprise 1 to 14 parts by weight of the paper/water admixture and 1.5 to 3.5 parts by weight of bonding agent. As will be appreciated by those skilled in the art, the relative amounts of the paper/water admixture to bonding agent can be selectively adjusted so as to impart desired properties to the resultant building material. For example, to the extent less glue and/or bonding agent is utilized, the resulting building material will have increased texture. Conversely, to the extent increased amounts of glue/bonding agent are utilized, the resultant building material will have a smoother appearance. To achieve such end result, it is presently contemplated that the building material, in an embodiment having a maximum amount of paper, can be formulated such that the building material consists of 14 parts of paper/water admixture and two parts bonding agent, wherein the bonding agent comprises one part thickening agent, comprised of cornstarch and water, and one part glue. In an alternative embodiment using a minimal amount of paper, the building material can consist of 1.0 part of the paper/water admixture and 1.5 parts bonding agent, wherein the bonding agent comprises 0.5 parts of the water/cornstarch thickening agent, and one part glue, all parts being by weight. In a more highly preferred embodiment, the resultant admixture will consist of approximately 7 parts by weight of the paper/water admixture and 3.5 parts by weight of bonding agent, wherein the bonding agent consists of 1.5 parts by weight of the thickening agent, and in particular the 1:8 cornstarch/water mixture, and 2.0 parts by weight of white glue.

With respect to the relative amounts of white glue and thickening agent, in one preferred embodiment, the same will consist of approximately 1 to 2 parts white glue and 0.5 to 1.5 percent thickening agent (especially if the same comprises cornstarch). In a more highly refined embodiment, the bonding agent will comprise approximately 2.0 parts of white glue by weight and 1.5 parts thickening agent (i.e., cornstarch) by weight of the bonding agent.

Once the paper and bonding agent have been combined according to the specified relative amounts of volume discussed above, the same are mixed in step 60 to form a mash. Along these lines, such mixing can be carried out in a variety of ways, including either mechanical or hand mixing. Preferably, such mixing step will be conducted until a wet, dough-like fibrous matrix is formed. As will be readily appreciated by those skilled in the art, the degree and duration of such mixing step 60 will be dependent upon a variety of factors, including the relative amounts of bonding agent to paper, the residual amount of water present in the paper/water admixture that remains during the straining step 40, and the desired aesthetic result.

Following the formation of the mash in step 60, an optional step 70 can be performed whereby a variety of additives or one or more other mashes can be combined to the mash to impart either desired properties and/or appearance characteristics in the final building material produced by the process 10. With respect to the additives, the same can comprise sand, plastic particles, larger paper shreds, confetti, metallic powder, string, or any of a variety of materials that can be mixed and integrated within the mash to thus enhance the appearance and texture of the resultant building material. Similarly, a wide variety of additives can be introduced into the mash to enhance the properties of the resultant building material. Exemplary of such additives include flame retardants, glosses, acrylics, hardeners, preservatives such as anti-oxidants, antimicrobial agents, dyes, scents/perfumes, or any other additive known in the art that would be compatible with various components comprising the building material, namely, the paper component and bonding agent.

Separate and apart from any additives that may be included as part of optional step 70 is the mixture of two or more mashes formed separately via steps 20-60. In this regard, it is contemplated that a first mash will be created using a first selection of a paper starting material to form a first mash by performing steps 20 through 60 and that at least one second mash will be produced using a dissimilar type of paper than that utilized in the first mash. For example, a first mash may be produced using red construction paper whereas a second mash may be produced using brown cardboard. Once each respective mash is formed, the same may be combined via step 70 to produce a combination mash that will consist of two dissimilar colors. As has been established through preliminary testing, the combination mash will be operative to produce vivid patterns of dissimilar colors that can produce an astonishingly pleasing aesthetic effect. Moreover, it will be expressly recognized by those skilled in the art that three, four, five or more separately produced mashes can optionally be combined via step 70 with the combined mash exhibiting properties of each respective mash. In this regard, it will be well understood by those skilled in the art that the relative amounts of each separately introduced mash can be adjusted in order to produce an overall appearance, which thus advantageously enables the building materials and methods of making the same according to the present invention operative to produce a customized appearance.

Along these lines, it has been shown that mixing multiple mashes can produce an effect simulating the appearance of any of a variety of types of granite. Moreover, by using dissimilar mashes, a customized texturized effect can be produced, as discussed more fully below, that has not heretofor been available utilizing existing building materials.

Once the mash has been formed in step 60 or otherwise modified via optional step 70, the same can then be applied to form an exterior surface covering or otherwise processed to manufacture any of a variety of building materials, as occurs in step 80. In this regard, the mash produced by the methods will initially exist as a wet, dough-like fibrous mix. During such state, the same can be directly applied to any of a variety of substrates, including plywood, hardboard, drywall or any other material well-known to those skilled in the art. To apply such materials, the same can be rolled (via a conventional paper roller) trowelled, stamped or otherwise spread across the surface to be covered. As will be readily appreciated by those skilled in the art, given the wet, dough-like consistency of the mash, the same can be applied to have a desired thickness. To the extent desired, the mash may be applied relatively thick and thereafter sculpted or molded to create raised patterns, as may be ideal for a given application. Alternatively, once applied to a given substrate, the mash can be pressed into shaped molds, similar to applications involving stamped concrete, which is well understood by those skilled in the art. Indeed, any type of artistic pattern may be readily impressed or formed within the mash while it remains in its wet state. In yet a further variation, the building material may be applied in a layer thin enough to allow for transparent applications, to thus enable the same to be utilized in certain lighting applications. Irrespective of such application, once applied, the mash is allowed to dry where it will form an extremely rigid and durable surface covering. Along these lines, it has been discovered that to the extent only a thickening agent, more specifically the water/cornstarch combination discussed above, is utilized as the sole bonding agent, the resultant building material, once allowed to dry, can be sanded or chiseled as may be desired.

In addition to direct application to a substrate, the mash may be separately processed for later integration into a structure or article of manufacture. In this respect, the mash, while in its wet, dough-like state, can be applied to a suitable casting, such as an aluminum sheet, and thereafter rolled thereacross to a desired, uniform thickness. Due to the smooth surface against which the mash is applied, and eventually hardens, a panel or layer of finished material can be formed that possesses a very smooth exterior surface, which can be utilized in a variety of applications. Indeed, to the extent the mash is not dried against such flat surface, and otherwise allowed to dry, the resultant building material that is produced will have a texturized surface and it is only when the mash is dried against a planar substrate that a smooth surface can readily be created. Similarly, to the extent it is desired to utilize the mash to form moldings and the like, the mash can be pressed into shape molds and thereafter dried and removed therefrom to possess the desired shape and characteristics.

In yet a further alternative, the building material may be packaged in its wet, dough-like state as a premixed material. Along these lines, it is contemplated that the building material may be fabricated on a mass scale according to several types of stock, colors, textures, and the like for subsequent application by consumer, such as homeowners or contractors.

Whether applied directly to the building materials or otherwise processed into building materials for subsequent utilization, the building materials as formed by the processes of the present invention can be treated with any of a variety of coatings, resins, waxes or any of a variety of other compounds well-known in the art to impart the desired characteristics of the finished building material. In this regard, the surface of the building material may be formed to be waterproof in nature for use in plumbing applications, made exceptionally durable for use in flooring applications, or made heat resistant for use in counter tops. Accordingly, any such further processing can be conducted utilizing known techniques in the art.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

1. A process for forming a building material for application to a substrate comprising the steps:
a) selecting a paper material;
b) combining said paper material in step a) with water to form a first admixture;
c) blending said first admixture produced in step b);
d) straining said blended admixture produced in step c);
e) combining said strained admixture produced in step d) with a bonding agent to form a second admixture; and
f) mixing said second admixture in step e) to form a mash.

2. The method of claim 1 wherein in step d), said blended admixture is strained such that the ratio of paper to water is approximately 3:16 by weight.

3. The method of claim 1 wherein in step e) said second admixture comprises from 1 to 14 parts by weight of said admixture and from 1.5 to 3.5 parts by weight of said bonding agent.

4. The method of claim 3 wherein in step e) said second admixture comprises approximately 7 parts by weight of said admixture and approximately 3.5 parts by weight of said bonding agent.

5. The method of claim 1 wherein in step e) said bonding agent comprises white glue.

6. The method of claim 5 wherein said bonding agent comprises the combination of white glue and a thickening agent.

7. The method of claim 6 wherein said thickening agent comprises a mixture of water and cornstarch.

8. The method of claim 7 wherein said bonding agent comprises from 1 to 2 parts by weight of white glue and from 0.5 to 1.5 parts thickening agent.

9. The method of claim 8 wherein said bonding agent comprises approximately 2.0 parts by weight of white glue and approximately 1.5 parts by weight thickening agent.

10. The method of claim 1 further comprising the step:
a) adding an additive to said mash formed in step f).

11. The method of claim 10 wherein said additive added to said mash is selected from the group consisting of sand, plastic particles, larger paper shreds, confetti, metallic powder and string.

12. The method of claim 10 wherein said additive added to said mash is selected from the group consisting of a flame retardant, a hardener, an antioxidant, a preservative, a dye, a scent and an antimicrobial agent.

13. The method of claim 1 wherein said method further comprises the step:
g) applying said mash formed in step f) to said substrate.

14. The method of claim 1 wherein said method further comprises the step:
a) forming said mash formed in step f) to assume a desired shape.

15. The method of claim 14 wherein said mash is formed as a molding.

16. The method of claim 14 wherein said mash is formed as a sheet.

17. The building material produced by the method of claim 1.

18. A building material for forming exterior surface upon a substrate comprising paper/water admixture and a bonding agent.

19. The building material of claim 18 wherein said paper material comprises 1 to 14 parts by weight of said paper/water admixture and said bonding agent ranges from 1.5 to 3.5 parts by weight of said admixture.

20. The building material of claim 19 wherein said building material comprises approximately 7 parts by weight of said paper/water admixture and said bonding agent comprises approximately 3.5 parts by weight of said admixture.

21. The building material of claim 19 wherein said bonding agent comprises the combination of white glue and a thickening agent.

22. The building material of claim 21 wherein said thickening agent comprises a mixture of water and cornstarch.

23. The building material of claim 22 wherein said white glue comprises from 1 to 2 parts by weight of said bonding agent and said thickening agent comprises 0.5 to 1.5 parts by weight of said bonding agent.
